(19) United States
(12) Patent Application Publication
(10) Pub. No.: US 2026/0337790 A1
(43) Pub. Date: Oct. 29, 2026

(54) GRAPHITE TO GRAPHENE EXFOLIATION UNDER HIGH MAGNETIC FLUX DENSITY IN SONO-ELECTRO-CHEMO CONDITIONS

(71) Applicants: Noorhana YAHYA, Perak (MY); Franky YASON, Jakarta (ID)

(72) Inventors: Noorhana YAHYA, Perak (MY); Franky YASON, Jakarta (ID)

(21) Appl. No.: 19/109,100

(22) PCT Filed: Sep. 11, 2023
(86) PCT No.: PCT/MY2023/050075

§ 371 Date: Mar. 5, 2025

(30) Foreign Application Priority Data
Sep. 29, 2022 (MY) PI 2022005413

(51) Int. Cl. C25B 9/60; B01J 8/40; B01J 8/42; C25B 1/135

(52) U.S. Cl. CPC C25B 9/60; B01J 8/40; B01J 8/42; C25B 1/135

(57) ABSTRACT

A system for exfoliating graphene from graphite, comprising a crusher (110) for crushing graphite; a sieve chamber (120) receives crushed graphite from the crusher (110) for sieving crushed graphite; an electrochemical chamber (130) for electrochemically exfoliating graphene from graphite; wherein the electrochemical chamber (130) having at least a pair of magnets (136, 1361) in a Lorentz force arrangement at opposing walls of the electrochemical chamber (130) to exfoliate crushed graphite by agitating the crushed graphite, and/or to exfoliate the graphene by exciting the graphene; and at least one refining chamber (140a-n) for refining graphene.

### FIELD OF INVENTION

The present invention generally relates to exfoliating graphene from graphite.

### BACKGROUND OF THE INVENTION

This section is intended only to provide background information pertaining to the similar field of the present invention, and may be used only to enhance the understanding of the present invention and not as admissions of prior art.

The current problem is the need to be able to effectively and efficiently extract graphene.

Chinese patent publication no. CN101634032A relates to an electrochemical preparation method for graphene, comprising the following steps: taking chemical and electrochemical stability metal and alloy or nonmetal conductor materials as a cathode and an anode, under the condition of stirring, the temperature of 5 below zero DEG C to 90 DEG C and a constant voltage of negative 1.5 V to 10.0negative V, electrolytic reduction is carried out on oxidation state graphene solution for 1 min to 10 h, to form high-quality graphene on the surface of a cathode electrode; or coating the oxidation state graphene solution on the surface of cathode materials in a dripping way to obtain the grapheme by reducing, and the grapheme is used for applications of modifying the electrode as biosense, and the like. In the method for preparing the graphene, an oxygen-containing functional group on oxidation state graphene is utilized to be reduced by obtaining electrons on the cathode.

U.S. Pat. No. 10,458,026B2 provides a method of producing graphene sheets comprising the steps of, forming a carbonaceous powder by electrochemical erosion of a graphite electrode in a molten salt comprising hydrogen ions, recovering the resulting carbonaceous powder from the molten salt liquid, and thermally treating the carbonaceous powder by heating the carbonaceous powder in a non-oxidising atmosphere to produce a thermally treated powder comprising graphene sheets.

Brazil patent application no. BR102013019478A2 provides a process of obtaining graphene by electrochemical exfoliation route. The present invention aims at demonstrating a simple, economically viable, environmentally friendly and efficient method for obtaining graphene from low cost carbon sources and low crystallinity. The starting material, graphite from depleted cells and/or scraps, is a three-dimensional arrangement which can be transformed into graphene through the electrochemical exfoliation process. Currently the starting materials for the production of graphene consist of materials of high structural organization and high cost to obtain.

The mentioned solutions are provide solutions to electrochemically extracting graphene from graphite, but do not provide effective and efficient refinement of graphene exfoliation from graphite.

The present invention seeks to overcome the above-mentioned limitations associated with existing solutions.

### SUMMARY OF INVENTION

In light of the limitations of the existing conventional systems as discussed above, it is evident that there arises a need of an effective and efficient means to exfoliate graphene from graphite.

In one aspect, embodiments of the present disclosure provides a system for exfoliating graphene from graphite, comprising a crusher (110) for crushing graphite; a sieve chamber (120) receives crushed graphite from the crusher (110) for sieving crushed graphite; an electrochemical chamber (130) for electrochemically exfoliating graphene from graphite; wherein the electrochemical chamber (130) having at least a pair of magnets (136, 1361) in a Lorentz force arrangement at opposing walls of the electrochemical chamber (130) to exfoliate crushed graphite by agitating the crushed graphite, and/or to exfoliate the graphene by exciting the graphene; and at least one refining chamber (140a-n) for refining graphene.

In another aspect, embodiments of the present disclosure provides a method of exfoliating graphene from graphite, comprising the steps of crushing graphite in a crusher (110); sieving crushed graphite in a sieve chamber (130); exfoliating graphene from graphite in an electrochemical chamber (130) with at least 1M of ionic compound electrolyte solution to ensure the ions are intercalated between the layers of graphite and loosen the Van der Waals forces that binds graphene sheets to graphite layers; agitating the graphite and graphene by at least a pair of magnets (136, 1361) at opposing walls of the electrochemical chamber (130) in a Lorentz force arrangement to agitate the graphite and graphene by Lorentz force.

### BRIEF DESCRIPTION OF DRAWINGS

The drawings mentioned herein disclose exemplary embodiments of the claimed invention. Detailed description and preparation of well-known compounds/substances/elements are omitted to not unnecessarily obscure the embodiments herein. Other objects, features, and advantages of the present invention will be apparent from the following description when read with reference to the accompanying drawing.

FIG. 1 illustrates a schematic illustration of a system for exfoliating graphene from graphite in accordance with an embodiment of the present disclosure;

FIG. 2 illustrates an illustration of a flow chart of a method for system for exfoliating graphene from graphite in accordance with an embodiment of the present disclosure;

FIG. 3 illustrates X-ray Diffraction (XRD) analysis of graphite sample indicates the presence of dominant minerals (i.e. Quartz, Muscovite and Zeolite);

FIG. 4 illustrates the electrical conductivity, G measurements over time of dispersed 15V electrochemical exfoliation graphite in 1M ammonium sulphate up to 24 hours settling period given;

FIG. 5 illustrates the electrical conductivity, G measurements over time of dispersed 20V electrochemical exfoliation graphite in 1M ammonium sulphate up to 24 hours settling period given;

FIG. 6 illustrates data analytics and statistical comparison plot of Capacitance, Cp at 50 Hz and 200 Hz frequency measurements of chemical exfoliation, electrochemical exfoliation and high magnetic flux condition electrochemical exfoliation of graphene using Zn and Al metal plates;

FIG. 7 illustrates data analytics and statistical comparison plot of Conductance, G at 50 Hz and 200 Hz frequency measurements of chemical exfoliation, electrochemical exfoliation and high magnetic flux condition electrochemical exfoliation of graphene using Zn and Al metal plates;

FIG. 8 illustrates data analytics and statistical comparison plot of Resistance, R at 50 Hz and 200 Hz frequency measurements of chemical exfoliation, electrochemical exfoliation and high magnetic flux condition electrochemical exfoliation of graphene using Zn and Al metal plates.

### DETAILED DESCRIPTION

This section is intended to provide explanation and description of various possible embodiments of the present invention. The embodiments used herein, and the various features and advantageous details thereof are explained more fully with reference to non-limiting embodiments illustrated in the accompanying drawing/s and detailed in the following description. The examples used herein are intended only to facilitate understanding of ways in which the embodiments may be practiced and to enable the person skilled in the art to practice the embodiments used herein. Also, the examples/embodiments described herein should not be construed as limiting the scope of the embodiments herein.

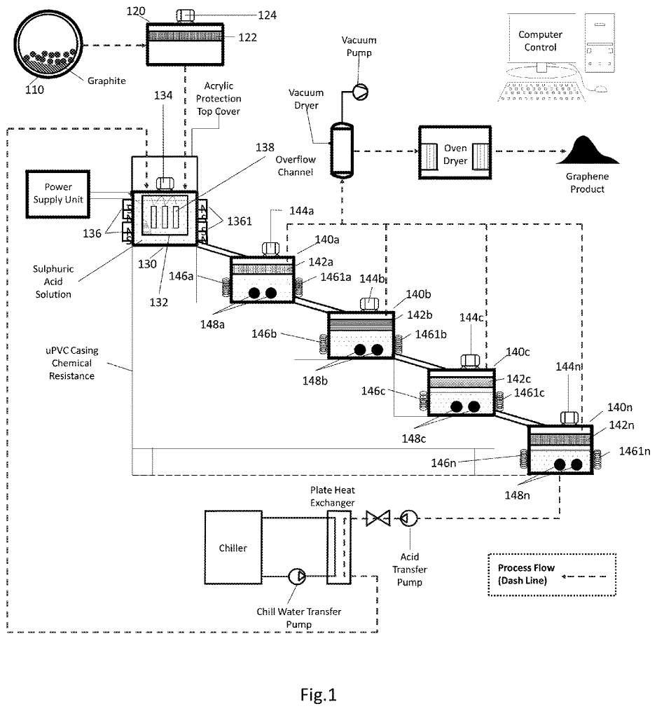

Referring to FIG. 1, a preferred embodiment of the present disclosure provides a system for exfoliating graphene from graphite, comprising a crusher (110) for crushing graphite; a sieve chamber (120) receives crushed graphite from the crusher (110) for sieving crushed graphite; an electrochemical chamber (130) for electrochemically exfoliating graphene from graphite; wherein the electrochemical chamber (130) having at least a pair of magnets (136, 1361) in a Lorentz force arrangement at opposing walls of the electrochemical chamber (130) to exfoliate crushed graphite by agitating the crushed graphite, and/or to exfoliate the graphene by exciting the graphene; and at least one refining chamber (140a-n) for refining graphene. The magnets (136, 1361) are permanent magnets arranged in a Lorentz force arrangement at opposing wall of the electrochemical chamber (130).

The magnets (136, 1361) can be made of Neodymium-Iron-Boron, Samarium-Cobalt, or a combination thereof, but not limited to such; are fixed to the walls of the electrochemical chamber (130) forming magnetic fields crossing over electric field results in upward-downward Lorentz force shifting with alternating current at varying frequencies. The abrupt change in the Lorentz force directions further upsets the Van der Waals intermolecular forces between graphite layers to exfoliate graphene.

The alternating current (A.C.) frequencies range between 200 Hz to 2 kHz, but not limited to such, which flips the ions moving direction aligned with high frequency oscillations.

The magnets (136, 1361) arrangement is North-North at first wall of the electrochemical chamber (130) and South-South at a second wall of the electrochemical chamber (130). Where the first wall and the second wall are opposing walls of the electrochemical chamber (130). The pairing of the first wall and second wall can be front and rear walls, left and right walls, top and bottom walls.

The combination of Lorentz force, ultrasonic vibration along with electrochemical exfoliation in the ionic and/or non-ionic compound electrolyte solution bath onto the exfoliated graphene is the floatation of the light-weight material. The floated graphene is washed through a weir into a refining chamber (140a-n).

The sieve chamber (120) comprises an ultrasonic vibrator (124) for agitating the crushed graphite to be sieved; and a sieve (122) for sieving the crushed graphite to be used in the electrochemical chamber (130). The crushed graphite material is sieved in the sieve chamber (120) with 50 mesh perforation, but not limited to 50 mesh, through which, finer particles of the graphite flakes with high surface area are separated from the coarser particles and sonicated at 1 MHz, but not limited to 1 MHz.

The electrochemical chamber (130) further comprises at least one cathode (138), wherein the cathode (138) having scratched lines to increase surface area; an anode (132) wherein the anode (132) is a mesh basket; and an ultrasonic vibrator (134) for agitating the crushed graphite and/or graphene. When the graphite is in contact with the anode (132) graphene is extracted from the graphite.

The anode (132) is of reactive metals as opposed to graphite (carbon) with electrochemical potential differences based on reactivity metals series and supplied with 50V electrical energy into the electrochemical bath, but not limited to 50V.

Example of reactivity metals that are used against graphite in the electrochemical chamber (130) can be aluminium, carbon, zinc, copper, or a combination thereof. As the redox potential of the metals and carbon complement to the further exfoliation of graphite. Copper and graphite have the largest potential difference, followed by aluminium and zinc to graphite, whereas graphite and carbon provides minimum potential difference.

The electrochemical chamber (130) contains an ionic and/or non-ionic compound electrolyte solution for the chemical exfoliation of graphene from graphite via ions intercalation to convert hydrophobic graphite to hydrophilic graphite. The finer graphite flakes are placed in the electrochemical chamber (130) and chemically exfoliated with 1M of ionic and/or non-ionic compound electrolyte solution, but not limited to 1M, to ensure the ions are intercalated between the layers of graphite and loosen the Van der Waals forces that binds the graphene sheets to graphite layers. The ionic compound electrolyte solution can be an ammonium sulphate solution, hydrochloric acid, sulphuric acid, or a combination thereof, but not limited to such. The non-ionic compound electrolyte solution can be an alcohol-based compound, hydrogen peroxide, or a combination thereof, but not limited to such. A person with knowledge of ionic and non-ionic compounds would be able to substitute the compounds mentioned with alternative ionic and non-ionic compounds. The ionic and/or non-ionic compound electrolyte solution used at various concentrations of 1M to 6M provides larger number of ions being intercalated at higher concentrations and improved the chemical exfoliation of graphene via improved ions intercalation. As such, provides a hydrophobic and/or hydrophilic solution environment with the graphene on the chemical interface.

The electrochemical chamber (130) operates at voltage supply range that drives ions mobility including the intercalated molecules that further upsets the Van der Waals forces between the graphite layers. The voltage supply range can be 5V to 50V, 50V to 100V, but not limited to such.

The refining chamber (140a-n) comprises an ultrasonic vibrator (144a-n) for agitating the graphene to be separated; a sieve (142a-n) for separating fine graphene from the larger graphene; at least a pair of solenoids (146a-n, 1461a-n) at opposing walls of the refining chamber (140a-n) to exfoliate the graphene by exciting the graphene. The solenoids (146a-n, 1461a-n) are in a Lorentz force arrangement.

The refining chamber (140a-n) further comprises at least a pair of permanent magnets (148a-n) in a Lorentz force arrangement. The permanent magnets (148a-n) are located at the base of the refining chamber (148a-n) in a Lorentz force arrangement.

The first refining chamber (140a-n) has a sieve (142a-n) and ultrasonic vibrator (144a-n) to allow finer and smaller layers of graphene to pass through the sieve (142a-n) upon the ultrasonication and high magnetic flux exfoliation. The sieve (142a) of the first refining chamber (142a-n) can be a 200-micromesh sieve, but not limited to such. The ultrasonic vibrator (144a-n) can operate at a frequency of 100 MHz, but not limited to such.

The second refining chamber (140b-n) has a sieve (142b-n) with finer mesh to further filter finer and smaller layers of graphene than those of the first refining chamber. The ultrasonic vibrator (144b-n) operates at a higher frequency than that of the first refining chamber (140b-n). Preferably, at a frequency 40% higher than the ultrasonic vibrator (140a-n) of the first refining chamber (140a-n).

The solenoids (146a-n, 1461a-n) can have the following arrangements, but not limited to such:

100-turn solenoid placed on opposing walls of the refining chamber (140a-n);

Two 50-turn solenoids placed side by side on opposing walls of the refining chamber (140a-n);

Two 50-turn solenoids placed on all sides and bottom of the refining chamber (140a-n);

Two 50-turn solenoids placed on all sides and bottom with permanent magnets; permanent magnets (148a-n) attached to the sides and bottom of the refining chamber (140a-n).

The arrangement creates a series of constructive waves as the magnetic flux from the solenoids (146a-n, 1461a-n) added together with in phase waves. Thus, a greater magnitude of Lorentz force is developed as the electrons carrying graphene falls onto the refining chamber (140a-n) that results in improved graphene exfoliation to produce fewer layers of graphene.

The graphene is refined through multiple refining chambers (140a-n) until the required graphene particle size is obtained.

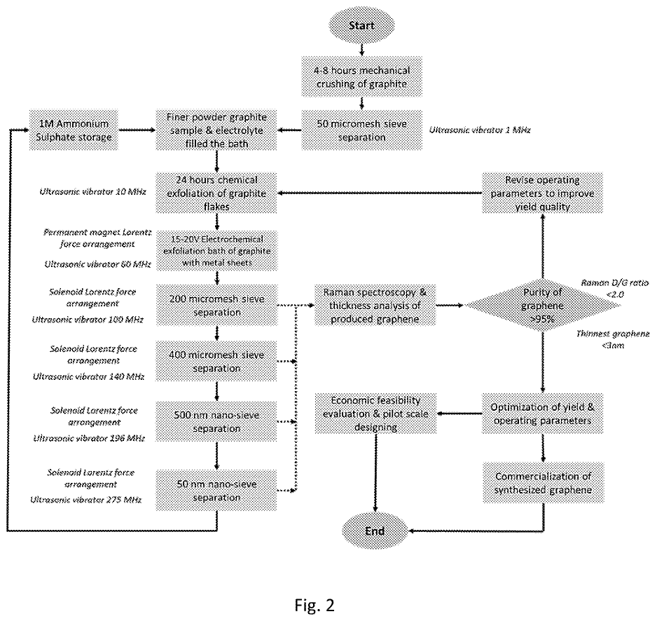

Referring to FIG. 2, in another preferred embodiment of the present invention provides a method of exfoliating graphene from graphite, comprising the steps of crushing graphite in a crusher (110); sieving crushed graphite in a sieve chamber (130); exfoliating graphene from graphite in an electrochemical chamber (130) with at least 1M of ionic compound electrolyte solution to ensure the ions are intercalated between the layers of graphite and loosen the Van der Waals forces that binds graphene sheets to graphite layers; agitating the graphite and graphene by at least a pair of magnets (136, 1361) at opposing walls of the electrochemical chamber (130) in a Lorentz force arrangement to agitate the graphite and graphene by Lorentz force.

The graphite flakes are soaked in preferably 1M of ionic compound electrolyte solution prior the electrochemical exfoliation. The ionic compound electrolyte solution can be an ammonium sulphate solution, hydrochloric acid, sulphuric acid, or a combination thereof. The chemical exfoliation via ions intercalation is performed via prior soaking of graphite flakes in 1M ammonium sulphate electrolyte is performed to convert hydrophobic graphite to hydrophilic graphite.

The method of exfoliating graphene from graphite further comprises the steps of exfoliating the graphene in a refining chamber (140a-n) by at least a pair of solenoids (146a-n, 1461a-n) at opposing walls of the refining chamber (140a-n) in a Lorentz force arrangement to agitate the graphite and graphene by Lorentz force; of separating fine graphene from the coarse graphene through a sieve (142a-n); and exfoliating the graphene in another refining chamber (140a-n) having a finer sieve (142a-n) than the previous refining chamber (140a-n) to obtain finer graphene particles.

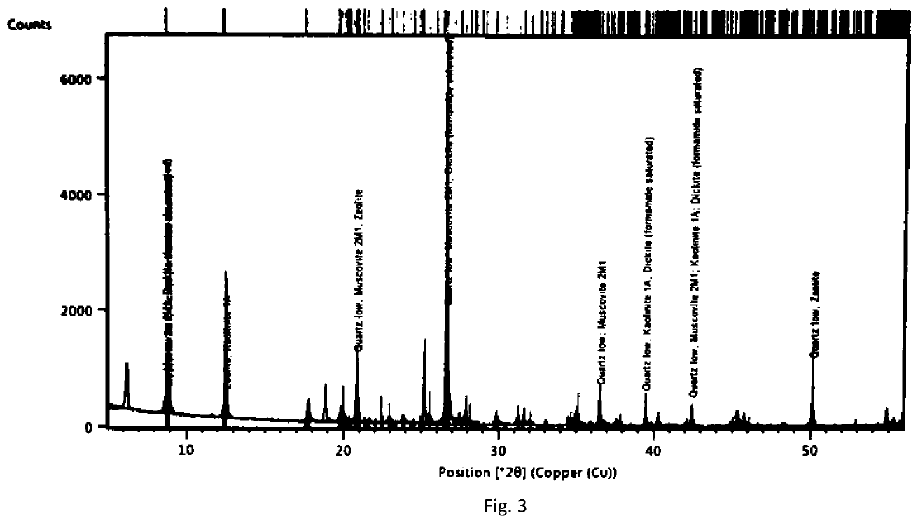

Referring to FIG. 3, the occurrence of other minerals in graphite such as Quartz (SiO₂), Muscovite ((KF)₂(Al₂O₃)₃(SiO₂)₆) and Zeolite (M_{2/n}OAl₂O₃·xSiO₂·yH₂O), indicates the dominant presence of silicate minerals in this graphite type. Silicate minerals with various crystal arrangements is considered as one of the major aspects to be considered in removal or separation of impurities prior to graphene production. Flake graphite types are commonly known to possess chemical compositions consisting of silicate and quartz minerals.

Raman spectroscopy and Ultraviolet (UV) Visible spectroscopy are performed onto the levels of exfoliated graphene that are trapped on the sieves (142a-n) to identify the process efficiency in producing high quality graphene (2-3 layers) from a larger graphite bulk input.

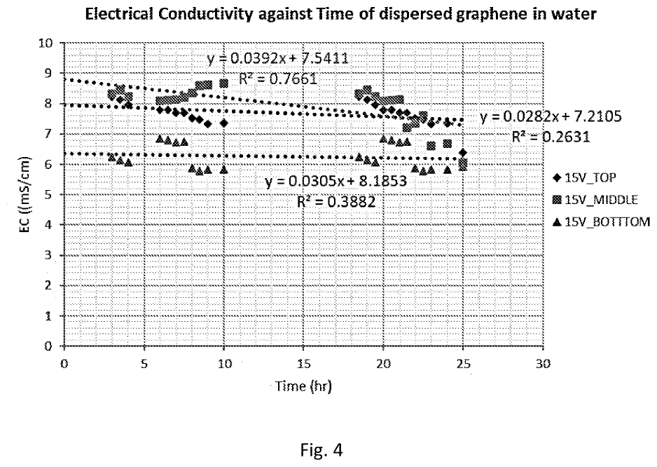

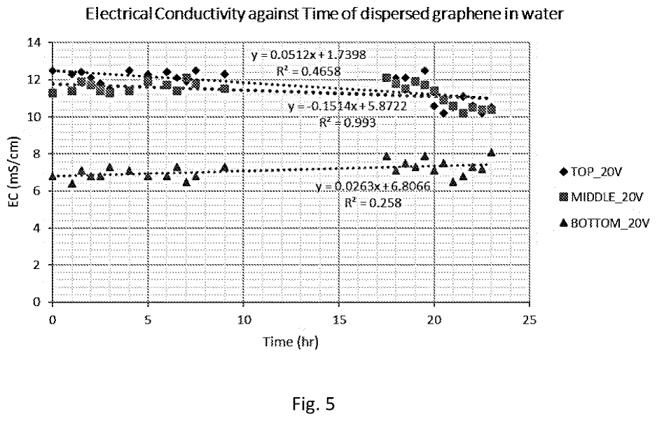

Referring to FIG. 4 and FIG. 5, the electrochemical exfoliation of graphene is conducted at 15 V and 20 V to determine the exfoliation of graphene using graphite flakes (anode) and bulk graphite (cathode) in 1M ammonium sulphate, (NH₄)₂SO₄, where the exfoliated graphite sample is dispersed in 90 °C distilled water. The suspension is identified as exfoliated graphene and unexfoliated graphite flakes deposited at the bottom of container. This is validated by the electrical conductivity, G of suspension (middle) and top layer are higher than deposited unexfoliated graphite flakes in both 15V and 20V electrochemical exfoliation over the observation period up to 24 hours. The ability for the dark suspension (graphene) at the middle and top segment of the container to sustain is consistent in 15V and 20V condition, nonetheless the suspension magnitude of electrical conductivity, G in 20V electrochemical exfoliation is up to 12.3 mS/cm, which is 33.33% higher than 15V supply.

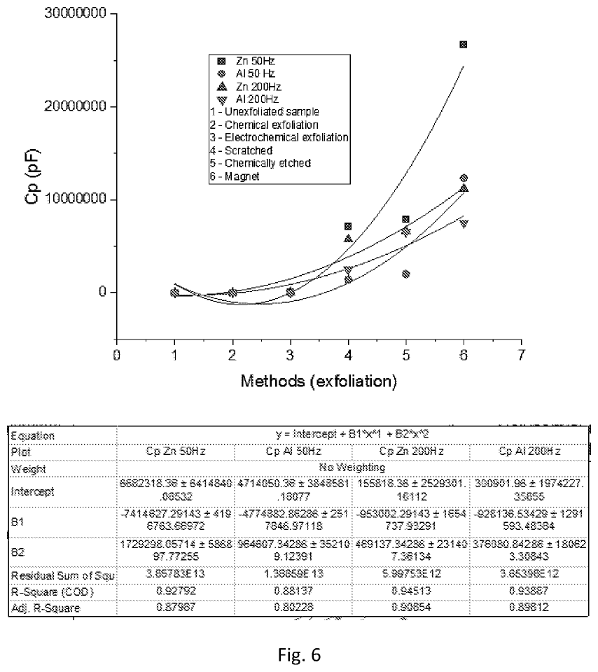

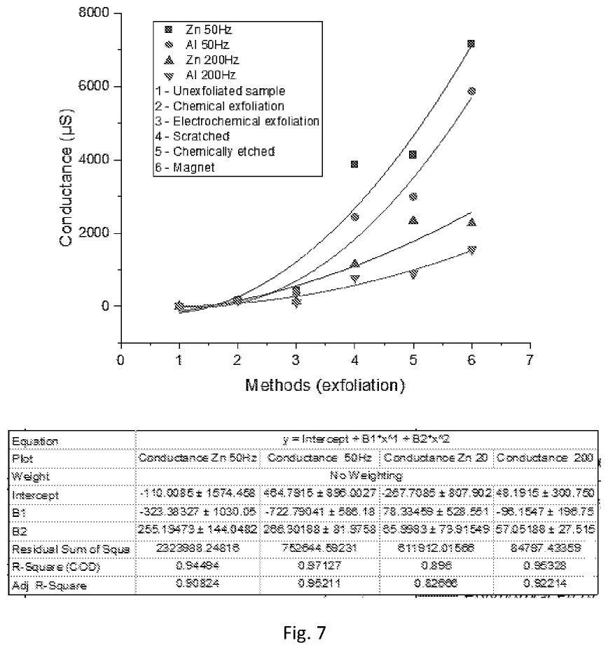

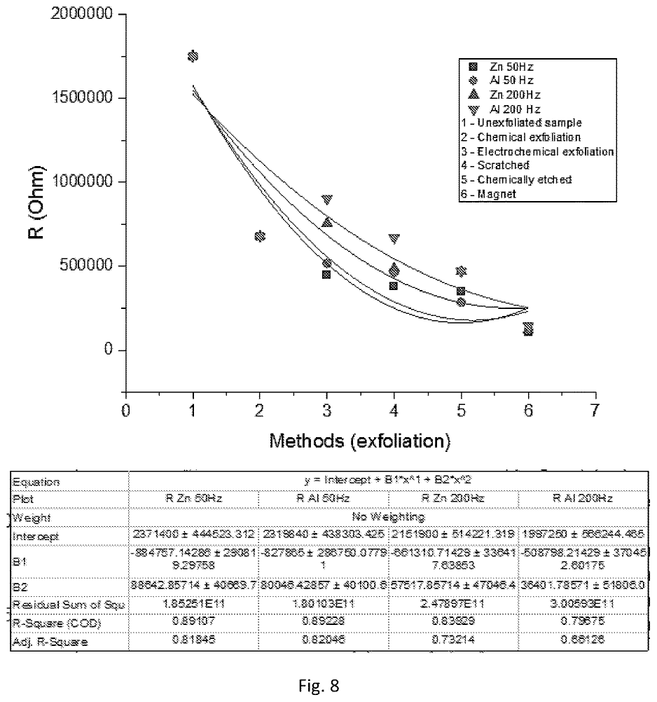

Referring to FIG. 6, FIG. 7, and FIG. 8, Through electrochemical exfoliation up to electrochemical exfoliation under high magnetic flux conditions, capacitance, Cp of exfoliated graphene using scratched Zn is 400% better than scratched Al at 20V supply. Furthermore, the conductance, G of scratched Zn is 50% higher than Al, followed by 21.2% higher graphene resistance from scratched Al. The application of electromagnetism onto the setup, which produces Lorentz force, FLorentz, a quantum leap in graphene capacitance, Cp (15.25×10⁶ % increase), electrical conductivity, G (1.7×10⁶ % increase) and resistance, R (1.490 % drop) are observed from both scratched Zn and Al, hence the huge influence of magnetic flux onto the upscaling for graphene mass production is undeniably supported by the data analytics and optimization.

As will be readily apparent to a person skilled in the art, the present invention may easily be produced in other specific forms without departing from its essential composition and properties. The present embodiments should be construed as merely illustrative and non-restrictive and the scope of the present invention being indicated by the claims rather than the foregoing description, and all changes which come within therefore intended to be embraced therein.

1. A system for exfoliating graphene from graphite, comprising:
a crusher (110) for crushing graphite;
a sieve chamber (120) receives crushed graphite from the crusher (110) for sieving crushed graphite;
an electrochemical chamber (130) for electrochemically exfoliating graphene from graphite; wherein the electrochemical chamber (130) having at least a pair of magnets (136, 1361) in a Lorentz force arrangement at opposing walls of the electrochemical chamber (130) to exfoliate crushed graphite by agitating the crushed graphite, and/or to exfoliate the graphene by exciting the graphene.

2. The system for exfoliating graphene from graphite as claimed in claim 1, further comprising at least one refining chamber (140a-n) for refining graphene.

3. The system for exfoliating graphene from graphite as claimed in claim 1, wherein the magnets (136, 1361) are permanent magnets in a Lorentz force arrangement.

4. The system for exfoliating graphene from graphite as claimed in claim 1, wherein the sieve chamber (120) comprising:
an ultrasonic vibrator (124) for agitating the crushed graphite to be sieved; and
a sieve (122) for sieving the crushed graphite to be used in the electrochemical chamber (130).

5. The system for exfoliating graphene from graphite as claimed in claim 1, wherein the electrochemical chamber (130) further comprising:
at least one cathode (138), wherein the cathode (138) having scratched lines to increase surface area;
an anode (132) wherein the anode (132) is a mesh basket; and
an ultrasonic vibrator (134) for agitating the crushed graphite and/or graphene.

6. The system for exfoliating graphene from graphite as claimed in claim 1, wherein the electrochemical chamber (130) contains an ionic compound electrolyte solution for the chemical exfoliation of graphene from graphite via ions intercalation.

7. The system for exfoliating graphene from graphite as claimed in claim 1, wherein the electrochemical chamber (130) contains an ionic compound electrolyte solution for the chemical exfoliation of graphene from graphite via ions intercalation to convert hydrophobic graphite to hydrophilic graphite.

8. The system for exfoliating graphene from graphite as claimed in claim 1, wherein the electrochemical chamber (130) contains a non-ionic compound electrolyte solution for the chemical exfoliation of graphene from graphite via ions intercalation.

9. The system for exfoliating graphene from graphite as claimed in claim 1, wherein the electrochemical chamber (130) contains a non-ionic compound electrolyte solution for the chemical exfoliation of graphene from graphite via ions intercalation to convert hydrophobic graphite to hydrophilic graphite.

10. The system for exfoliating graphene from graphite as claimed in claim 2, wherein the refining chamber (140a-n) comprises:
an ultrasonic vibrator (144a-n) for agitating the graphene to be separated;
a sieve (142a-n) for separating fine graphene from the larger graphene;
at least a pair of solenoids (146a-n, 1461a-n) at opposing walls of the refining chamber (140a-n) to exfoliate the graphene by exciting the graphene.

11. The system for exfoliating graphene from graphite as claimed in claim 8, wherein the refining chamber (140a-n) further comprises at least a pair of permanent magnets (148a-n) in a Lorentz force arrangement.

12. The system for exfoliating graphene from graphite as claimed in claim 8, wherein the solenoids (146a-n, 1461a-n) are in a Lorentz force arrangement.

13. The system for exfoliating graphene from graphite as claimed in claim 9, wherein the permanent magnets (148a-n) are located at the base of the refining chamber (148a-n) in a Lorentz force arrangement.

14. A method of exfoliating graphene from graphite, comprising the steps of:
crushing graphite in a crusher (110);
sieving crushed graphite in a sieve chamber (130);
exfoliating graphene from graphite in an electrochemical chamber (130) with at least 1M of ionic compound electrolyte solution to ensure the ions are intercalated between the layers of graphite and loosen the Van der Waals forces that binds graphene sheets to graphite layers;
agitating the graphite and graphene by at least a pair of magnets (136, 1361) at opposing walls of the electrochemical chamber (130) in a Lorentz force arrangement to agitate the graphite and graphene by Lorentz force.

15. The method of exfoliating graphene from graphite of claim 12, further comprising the step of exfoliating the graphene in a refining chamber (140a-n) by at least a pair of solenoids (146a-n, 1461a-n) at opposing walls of the refining chamber (140a-n) in a Lorentz force arrangement to agitate the graphite and graphene by Lorentz force.

16. The method of exfoliating graphene from graphite of claim 13, further comprising the step of separating fine graphene from the coarse graphene through a sieve (142a-n).

17. The method of exfoliating graphene from graphite of claim 14, further comprising the step of exfoliating the graphene in another refining chamber (140a-n) having a finer sieve (142a-n) than the previous refining chamber (140a-n) to obtain finer graphene particles.
